(19) United States
(12) Patent Application Publication
(10) Pub. No.: US 2014/0046812 A1
(43) Pub. Date: Feb. 13, 2014

(54) EXPENSE REPORTS FOR PAYMENTS MADE WITH A MOBILE DEVICE

(71) Applicants: Yang-cheng FAN, San Jose, CA (US); Mario LINGE, Mountain View, CA (US)

(72) Inventors: Yang-cheng FAN, San Jose, CA (US); Mario LINGE, Mountain View, CA (US)

(73) Assignee: SAP AG, Walldorf (DE)

(21) Appl. No.: 13/568,948

(22) Filed: Aug. 7, 2012

(51) Int. Cl. G06Q 40/00

(52) U.S. Cl. 705/30

(57) ABSTRACT

Creating expense reports in a remote business system for payments made with a mobile computing device by: making an electronic payment using a mobile computing device, for example via Near Field Communication; collecting data from the mobile device that is relevant to the submission of an expense report for the payment in the remote business system; creating an expense object associated with the electronic payment on the mobile computing device; transmitting the expense object to the remote business system if the mobile computing device has a connection to the remote business system; and creating an expense report in the remote business system based on the expense object. The collected data may include, for example, data regarding: amount of the payment; nature of items or services purchased the payee; a client account to be billed; user of the mobile computing device; time of the payment; or location of the payment.

### BACKGROUND

For many companies business travelers are among the most highly compensated employees within the organization and are often traveling to meet with important clients or potential clients or to meet other key organizational objectives. The time of such business travelers is extremely valuable and having to remember or log every detail of every travel expense is simply not an efficient use of a valuable resource. Therefore efficiency may be improved if efforts are made to simplify the process with the objective of minimizing time spent creating and submitting expense reports.

Increasingly mobile computing devices are used by business travelers when on the road and expense creation and submission capabilities via smart phone platforms offer significant new capabilities for simplification of the process of generating expense reports. For example, by simplifying and accelerating the user experience most business travelers, across the spectrum of technical aptitude, can easily and effectively create and submit expense reports with little training. Furthermore, it is now possible to make electronic payments to certain vendors via mobile devices like smart phones allowing for still more automation in the generation of expense reports.

Automating travel and expense management may also enhance transparency, increase compliance to corporate policies, reduce fraud, and ultimately drive significant reductions in expenditures within many organizations.

### SUMMARY

The above-noted issues may be addressed in the form of expense objects which may be automatically created on a mobile computing device after an electronic payment is made by a business traveler using the mobile computing device. Information needed for submitting an expense report in a remote business system may be extracted from the mobile computing devices memory or sensors or from an electronic receipt received for the electronic payment and an expense object capable of communicating with the remote business system may be generated based on the extracted information. In this ways, transmitting the expense object associated with an electronic payment (e.g. via Internet connection) to the remote business system of the organization may represent a virtually complete expense report submission for the payment.

A travel expense management application may be running on a mobile computing device when making an electronic payment using the mobile computing device, for example via Near Field Communication. An expense object associated with the electronic payment may be generated on the mobile computing device and then transmitted to a remote business system if the mobile computing device has a connection to the remote business system. An expense report may then be generated in the remote business system based on the expense object which includes data regarding the payment transaction and other data relevant to the submission of an expense report in the remote business system obtained from the mobile device, for example, data regarding: the amount of the payment; the payee; a client account to be billed; a user of the mobile computing device; the time of the payment; or the location of the payment.

### BRIEF DESCRIPTION OF THE DRAWINGS

FIG. 1 shows an example system and processing flow according to the present invention.

FIG. 2 shows an example method according to the present invention.

### DETAILED DESCRIPTION

Embodiments of the present invention will now be described in detail, by way of example only, with reference to the accompanying drawings in which identical or corresponding parts/features are provided with the same reference numerals in the figures.

A travel expense management application running on a mobile computing device when making an electronic payment using the mobile computing device collects data relevant to the submission of an expense report in a remote business system and generates an expense object associated with the electronic payment and capable of communicating with the remote business system based on the collected data. The expense object may then be transmitted to the remote business system so that an expense report may be generated based on the expense object. For example the expense object may instruct the remote business system to launch the application for submitting expense reports and fill in each of the required fields for the submission of such a report in the remote business system. The application may be configured to be operational with general purpose or special purpose mobile computing systems, such as hand-held devices or laptop devices.

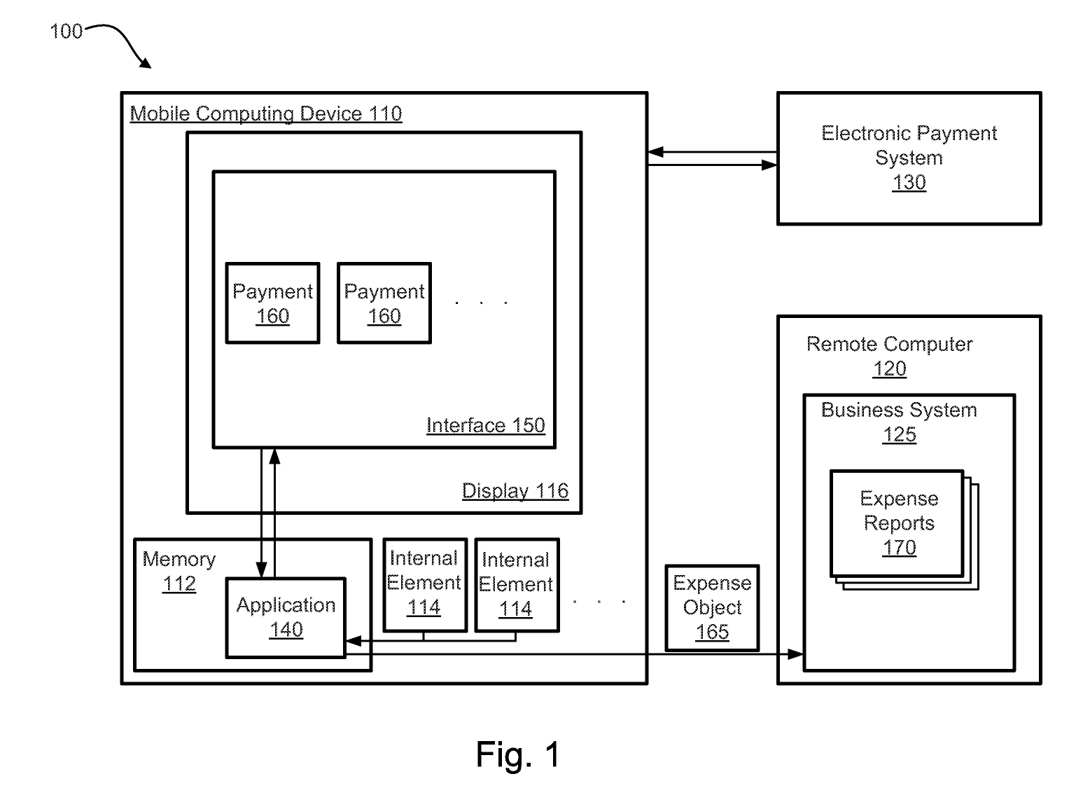

FIG. 1 shows an example computer system 100 for implementing the automatic generation of expense reports for electronic payments made with a general purpose mobile computing device 110. Mobile computing device 110 typically includes a variety of computer readable media (e.g. system memory 112) including both volatile and nonvolatile, removable and non-removable media implemented in any method or technology for storage of information such as computer readable instructions, data structures, program modules or other data.

The mobile computing device 110 may include other internal elements 114 (e.g. Global Positioning System (GPS) sensor or internal clock) for providing the user of the device 110 with relevant information. A display 116 is provided for displaying the interface of the application to the user although mobile computing device 110 may also include other peripheral output devices such as speakers or printers.

The mobile computing device 110 may operate in a networked environment using logical connections to one or more remote computers, such as a remote computer 120. The remote computer 120 may be a network PC connected via a local area network (LAN) and/or a wide area network (WAN), but may also include other networks. Networking environments are commonplace in offices, enterprise-wide computer networks, intranets and the Internet. It will be obvious to one skilled in the art that any other means of establishing a communications link between a mobile computing device and a computer may be used.

Computer system 100 includes a business system 125 stored on remote computer 120. Computer system 100 also includes an electronic payment system 130 provided by, for example, a vendor of goods or services. A user of mobile computing device 110 may make an electronic payment 150 with the device 110 through the electronic payment system 130, for example via Near Field Communication (NFC), Bluetooth or WiFi communication. Furthermore, as shown in FIG. 1 computing system 100 also includes a travel expense management application 140 which is capable of transmitting data to business system 125 stored on remote computer 120. The application program 140 interfaces with data stored on the mobile computing device 110 through an application interface 150 depending upon the nature of the data formatting used by respective sources of data being accessed by the application program 140. In particular, the application program 140 may interface with the data from internal components of the mobile computing device 110 (e.g. 112 or 114) and also with stored information regarding the electronic payment transaction, for example an electronic receipt provided by commercially available electronic payment systems for electronic payments.

The mobile computing device 110 may include payment data (e.g. amount of the payment, items or services purchased, payee, or client account to be billed) which may be extracted, for example, from an electronic receipt for an electronic payment 160 or other data relevant to the submission of an expense report 170 in business system 125 (e.g. user, time or place data) which may extracted from other components of the mobile computing device 110, e.g. location details from a GPS sensor 114. This data may be collected and displayed to a user of the device 110 on display 116 through application interface 150. Different mobile devices and electronic payment systems may have different data structures or formats requiring a specific application interface 150 in order for the application program 140 to communicate with, and retrieve data from, the relevant data sources of mobile computing device 110. The application program 140 may provide the user with the option of reviewing and or editing the collected data associated with an electronic payment 160 on display 116 through the application interface 150 before application program 140 generates an expense object 165 associated with the payment 160. The expense object 165 communicates with business system 125 and may include the collected (and possibly user edited) data relevant to the submission of an expense report 170 in business system 125 for the associated electronic payment 160. The application program 140 may generate the expense object 165 automatically after an electronic payment 160 has been made or the expense object 165 may be generated in response to user input through the application interface 150 after the user has reviewed and/or edited the data associated with the electronic payment 160 on display 116 as mentioned above.

The application program 140 includes a functionality for transmitting data to remote computer 120 by connecting to remote computer 120 via, for example, the Internet. It will be obvious to one skilled in the art that any other means of establishing a communications link between the device 110 and the computer 120 be used, for example via NFC, Bluetooth or WiFi communication. If at least one such connection between mobile computing device 110 and remote computer 120 is present then the expense objects 165 which have been generated within mobile computing device 110 may be transmitted to business system 125 on remote computer 120. The expense objects 165 are capable of communicating with business system 125 and the data within the expense object 165 may be formatted so as to be readily understandable by business system 125 of remote computer 120. Expense reports 170 may then be generated within business system 125 of remote computer 120 based on each of the expense objects 165 received by business system 125 of remote computer 120.

The application program 140 may be compatible with different business systems 125 with diverse formats and data structures. As mentioned above, in order to interface with different business systems 125, a system specific format must be used for the expense objects 165 generated within mobile computing device 110 for each electronic payment 160.

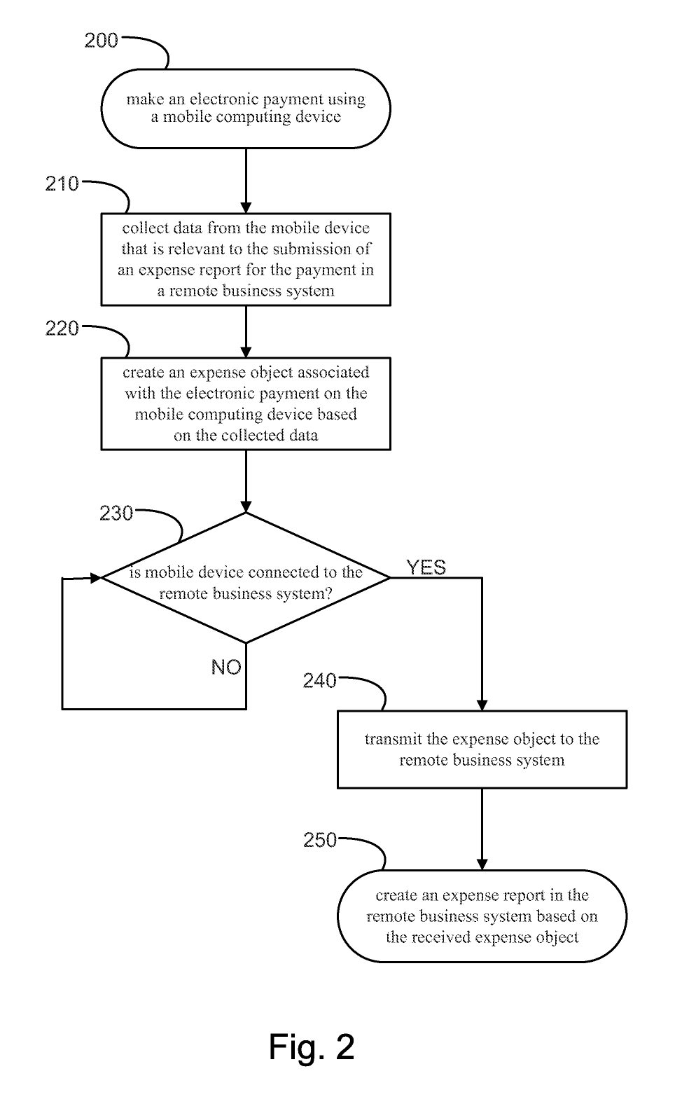

FIG. 2, illustrates an example method for creating expense reports in a remote business system for electronic payments made with a mobile computing device like mobile computing device 110.

In step 200 a mobile computing device 110 may be used to make an electronic payment 160 through an electronic payment system 130. As explained above, information regarding the electronic payment 160 is stored on mobile computing device 110, for example an electronic receipt provided by electronic payment system 130 for electronic payments. In step 210 an expense object 165 associated with the electronic payment 160 is generated on the mobile computing device 110 based on the collected data associated with the electronic payment 160. Expense object 165 may include the details of the electronic payment 160 and may be generated automatically after an electronic payment 160 has been made or in response to user input after the user has reviewed and or edited the data associated with the electronic payment 160 on display 116 of mobile computing device 110. Because the expense object 165 may be transmitted to a remote business system for further processing, the object 165 must be formatted so that it is compatible with any such remote business system to which the object 165 may be transmitted. In step 220 data is collected from the mobile device that is relevant to the submission of an expense report for the payment in the remote business system. As mentioned above the collected data may include payment data (e.g. amount of the payment, payee, or client account to be billed) or other data relevant to the submission of an expense report 170 in business system 125 (e.g. user, time or place data). In step 230 the mobile device 110 determines if the necessary connection for transmitting data between mobile computing device 110 and remote computer 120 exists, for example an Internet connection. If a connection is found to be present in step 220 then, in step 240 the expense object 165 may be transmitted to the business system 125 of remote computer 120. In step 250 expense reports 170 may be generated within business system 125 of remote computer 120 based on each of the expense objects 165 received by business system 125 of remote computer 120.

Embodiments of the present invention are described in the context of a fully functional computer system, however those skilled in the art will appreciate that modules of the present invention are capable of being distributed in a variety of forms across a plurality of systems. Embodiments consistent with the invention may also include one or more programs or program modules on different computing systems running separately and independently of each other, while in their entirety being capable of performing business transactions in a large enterprise environment or in a “software on demand” environment. These programs or program modules may be contained on signal bearing media that may include: recordable type media such as floppy disks and CD ROMS, and transmission type media such as digital and analog communication links, including wireless communication links.

The foregoing description is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

We claim:

1. A method for creating expense reports in a remote business system for payments made with a mobile computing device, the method comprising:
making an electronic payment using a mobile computing device;
collecting data from the mobile device that is relevant to the submission of an expense report for the payment in the remote business system;
creating an expense object associated with the electronic payment on the mobile computing device based on the collected data;
transmitting the expense object to the remote business system; and
creating an expense report in the remote business system based on the received expense object.

2. The method of claim 1, wherein the electronic payment is made using Near Field Communication.

3. The method of claim 1, wherein the collected data that is relevant to the submission of an expense report for the payment in the remote business system includes data regarding: i) amount of the payment; ii) items or services purchased; iii) payee; or iv) client account to be billed.

4. The method of claim 3, wherein the collected data that is relevant to the submission of an expense report for the payment in the remote business system includes data regarding: i) user of the mobile computing device; ii) time of the payment; or iii) location of the payment.

5. The method of claim 4, further comprising editing the collected data before the expense object is created.

6. The method of claim 1, wherein the transmitting of the expense object is performed if the mobile computing device has an internet connection to the remote business system.

7. The method of claim 1, wherein the transmitting of the expense object is performed if the mobile computing device has a: i) WiFi; ii) Bluetooth; or iii) Near Field Communication connection to the remote business system.

8. A non-transitory computer-readable medium having stored thereon instructions adapted to be executed by a processor, the instructions which, when executed, cause the processor to perform a method for creating expense reports in a remote business system for payments made with a mobile computing device, comprising:
making an electronic payment using a mobile computing device;
collecting data from the mobile device that is relevant to the submission of an expense report for the payment in the remote business system;
creating an expense object associated with the electronic payment on the mobile computing device;
transmitting the expense object to the remote business system; and
creating an expense report in the remote business system based on the received expense object.

9. The computer-readable medium of claim 8, wherein the electronic payment is made using Near Field Communication.

10. The computer-readable medium of claim 8, wherein the collected data that is relevant to the submission of an expense report for the payment in the remote business system includes data regarding: i) amount of the payment; ii) items or services purchased; iii) payee; or iv) client account to be billed.

11. The computer-readable medium of claim 10, wherein the collected data that is relevant to the submission of an expense report for the payment in the remote business system includes data regarding: i) user of the mobile computing device; ii) time of the payment; or iii) location of the payment.

12. The method of claim 11, further comprising editing the collected data before the expense object is created.

13. The computer-readable medium of claim 8, wherein the transmitting of the expense object is performed if the mobile computing device has an internet connection to the remote business system.

14. The computer-readable medium of claim 8, wherein the transmitting of the expense object is performed if the mobile computing device has a: i) WiFi; ii) Bluetooth; or iii) Near Field Communication connection to the remote business system.

15. A system for creating expense reports in a remote business system for payments made with a mobile computing device, comprising:
at least one remote business system including a processor and memory; and
a mobile computing device including a processor and memory; and
an application program for collecting data regarding electronic payments made using the mobile computing device;
wherein, the system is configured to:
make an electronic payment using the mobile computing device;
collect data from the mobile device that is relevant to the submission of an expense report for the payment in the remote business system;
create an expense object associated with the electronic payment on the mobile computing device;
transmit the expense object to the remote business system; and
create an expense report in the remote business system based on the received expense object.

16. The system of claim 15, wherein the mobile computing device is configured to make the electronic payment using Near Field Communication.

17. The system of claim 15, wherein the application program is configured to collect data that is relevant to the submission of an expense report for the payment in the remote business system including data regarding: i) amount of the payment; ii) items or services purchased; iii) payee; or iv) client account to be billed.

18. The system of claim 17, wherein the application program is configured to collect data that is relevant to the submission of an expense report for the payment in the remote business system including data regarding: i) user of the mobile computing device; ii) time of the payment; or iii) location of the payment.

19. The method of claim 18, further comprising editing the collected data before the expense object is created.

20. The system of claim 15, wherein the application program is configured to transmit the expense object if the mobile computing device has an internet connection to the remote business system.

21. The system of claim 15, wherein the application program is configured to transmit the expense object if the mobile computing device has a: i) WiFi; ii) Bluetooth; or iii) Near Field Communication connection to the remote business system.
